(19) United States
(12) Patent Application Publication
(10) Pub. No.: US 2005/0190317 A1
(43) Pub. Date: Sep. 1, 2005

(54) Liquid crystal display device and backlight module thereof and light assembly of backlight module

(76) Inventors: Chien Ming Wan, Feng Shan city (TW); Eszu Fong Lee, Huatan Shiang (TW); Sheng Hao Huang, Chungli city (TW); Chen-Yuan Chen, Kaohsiung City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/996,385

(22) Filed: Nov. 26, 2004

(30) Foreign Application Priority Data
Dec. 8, 2003 (TW) 092134609
Mar. 17, 2004 (TW) 093107086

(51) Int. Cl. G02F 1/1333

(52) U.S. Cl. 349/58

(57) ABSTRACT

A light assembly mainly includes a lamp and a lamp holder. The lamp has a pair of first ends and the lamp holder has a pair of second ends, wherein the second ends of the lamp holder are coupled with the first ends of the lamp. The lamp holder includes a pair of stoppers on the second ends of the lamp holder. The present invention further provides a backlight module using the light assembly therein, and a liquid crystal display device using the backlight module therein.

This application claims the priority benefit of Taiwan Patent Application Serial No. 092134609, filed Dec. 18, 2003 and Taiwan Patent Application Serial No. 093107086, filed Mar. 17, 2004, the full disclosures of which are incorporated herein by reference.

### BACKGROUND OF THE INVENTION

1 Field of the Invention

The present invention generally relates to a liquid crystal display device, and more particularly to a backlight module thereof.

2. Description of the Related Art

Typically, the liquid crystal display device includes a liquid crystal panel (which has two substrates and a liquid crystal layer sealed therebetween) and an illuminative means, e.g. a backlight module mounted under the liquid crystal panel. The back light module is utilized to distribute the light from a light source uniformly over the surface of the liquid crystal panel.

As shown in FIG. 1, the backlight module 100 includes a lamp assembly 102 and a series of stacked sheets 104 for receiving and embellishing the light. Typically, the light assembly 102 includes a lamp 102a and a lamp holder 102b. The stacked sheets 104 in sequence include a protective sheet (not shown), a prism sheet (not shown), a diffusing sheet (not shown), a light guide plate 104a and a reflective sheet 104b. The light assembly 102 and the stacked sheets 104 are disposed in a housing 106, wherein the light assembly 102 is mounted at a side of the housing 106.

The liquid crystal display device is often applied to the portable electronic apparatus, and therefore light or thin property is one of important conditions. The light guide plate 104a of the liquid crystal display device has different thickness between at the side which is provided with the lamp and at the other side which is opposite thereto. Preferably, the thickness of the light guide plate 104a is gradually decreased from the side which is provided with the lamp to the other side which is opposite thereto so as to improve the diffusion of the light.

In addition, the durability is also one of important conditions of the liquid crystal display device which is applied to the portable electronic apparatus. When the liquid crystal display device is rammed outside (e.g. during ramming test or the liquid crystal display device which falls down to the ground), the light guide plate 104a of the backlight module 100 can be removed to the light assembly 102 so as to easily damage the lamp 102a. In the prior art, in order to avoid removing the light guide plate 104a to the light assembly 102, the light guide plate 104a provided with at least one pair of protrusions 114 are snapped into the housing 106 provided with at least one pair of concaves 116 corresponding to the protrusions 114.

The light guide plate 104a has larger thickness and mass at the position near the lamp 102a, and therefore the protrusions 114 must be disposed at the position near the lamp 102a. However, the geometric figure of the protrusions 114 is different from the geometric figure of other position of the light guide plate 104a, and therefore there are problems of uneven illumination and light leakage easily at the protrusions 114. For above reasons, the protrusions of the optical sheet must be specially designed to improve the optical property, but it will increase the difficulty of manufacture of the optical sheet. In addition, in order to concentrate the light, an adhesive tape (not shown) must be attached above the side near the optical sheet. However, it is difficult to attach the adhesive tape because the protrusion 114 is provided. Furthermore, the adhesive tape is not easily securely attached to the protrusion 114.

U.S. Pat. No. 6,392,724 entitled “LCD Module Having Improved Fixing Structure”, disclosed that a fixing unit is located at a frame of a liquid crystal display device. However, when the liquid crystal display device is large dimension, it will increase difficulty of manufacture of the frame because the frame is rectangular structure and must match with the fixing unit. Furthermore, the fixing unit is an additional component and therefore the whole cost of the liquid crystal display device can be also increased.

### SUMMARY OF THE INVENTION

Accordingly, it is an object of the present invention to provide a lamp assembly which is applied to a backlight module of a liquid crystal display device and includes a lamp holder having a novel stopper for preventing a optical sheet from contacting a lamp, thereby solving the above-mentioned problems in the prior art.

It is another object of the present invention to provide a lamp assembly which is applied to a backlight module of a liquid crystal display device and includes a lamp holder having at least one stopper for mounting an optical sheet of the backlight module.

The backlight module according to the present invention includes a lamp assembly and an optical sheet disposed inside a housing. The lamp assembly includes a lamp and a lamp holder. The lamp holder is mounted in the housing. The lamp has a pair of first ends, and the lamp holder has a pair of second ends connected with the first ends of the lamp. The present invention is characterized in that the lamp holder includes a pair of first stoppers which are disposed at the second ends of the lamp holder and located between the lamp and the optical sheet, thereby preventing the optical sheet from contacting the lamp.

The lamp holder generally has an upper wall and a lower wall opposite to the upper wall. According to an embodiment of the present invention, the upper wall has a protrudent portion and the first stopper is formed by bending the protrudent portion of the upper wall. According to another embodiment of the present invention, the first stoppers are formed by cutting and bending the lower wall.

The lamp assembly generally has a pair of elastic elements which are respectively disposed between the first ends of the lamp and the second ends of the lamp holder. In order to avoid the light emitted from the lamp being obstructed by the stopper of the lamp holder, the length of the stopper of the present invention is preferably the same as the length of the elastic element.

Preferably, the lamp holder further includes at least one second stopper, e.g. two stoppers which are respectively disposed near the two ends of the lamp holder. The second stoppers are formed by cutting and bending the lower wall of the lamp holder. The optical sheet has at least one concave corresponding to the second stoppers for snapping to the second stoppers so as to mount the optical sheet. The contact between the second stoppers and the optical sheet can be plane, line or point so as to restrict the optical sheet to be removed forward or backward in the direction of the lamp. In other words, the freedom degree of the direction of the lamp is restricted, and therefore during ramming test the present invention can prevent the optical sheet separating from the housing so as to increase the durability of the backlight module.

The present invention further provides a liquid crystal display device, which includes the above-mentioned backlight module, a liquid crystal panel and a frame. The liquid crystal panel is disposed on the backlight module. The frame is joined with the housing for mounting the liquid crystal panel therebetween.

The lamp assembly of the present invention has a novel stopper. When the stopper is disposed on a backlight module, the stopper is disposed between the lamp and the optical sheet, thereby preventing the optical sheet from contacting the lamp. Thus, when the lamp assembly is applied to the backlight module, the optical sheet can be a structure without the protrusion, thereby solving the problem of the optical design of the protrusion of the optical sheet, making it easier to attach the adhesive tape to the side of the optical sheet, or fully omitting the adhesive tape.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded perspective view of a backlight module in the prior art.

FIG. 2 is an exploded perspective view of a liquid crystal display device according to an embodiment of the present invention.

FIG. 3 is an exploded perspective view of a backlight module according to an embodiment of the present invention.

FIG. 4 is a partially perspective view of a backlight module according to an embodiment of the present invention, showing a stopper of a lamp holder.

FIG. 5 is a partially perspective view of a backlight module according to another embodiment of the present invention, showing a stopper of a lamp holder.

FIG. 6 is an exploded perspective view of a backlight module according to further embodiment of the present invention.

FIG. 7 is a partially perspective view of a backlight module according to further embodiment of the present invention, showing a stopper of a lamp holder.

FIG. 8 is an exploded perspective view of a backlight module according to still further embodiment of the present invention.

FIG. 9 is a partially perspective view of a backlight module according to still further embodiment of the present invention, showing a stopper of a lamp holder.

### DETAILED DESCRIPTION OF THE PREFERRED EMBODIMENTS

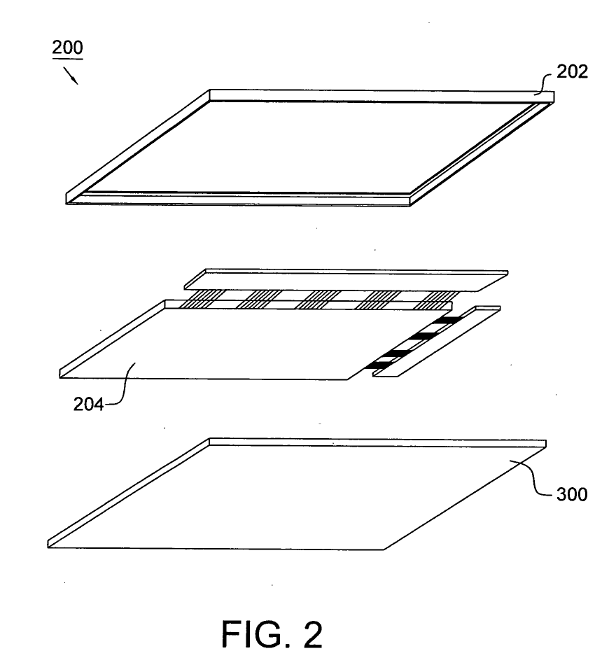

Referring to FIG. 2, it depicts a liquid crystal display device 200 according to an embodiment of the present invention. The liquid crystal display device 200 includes a frame 202, a liquid crystal panel 204 for displaying image and a backlight module 300 for providing the liquid crystal panel 204 with a light source.

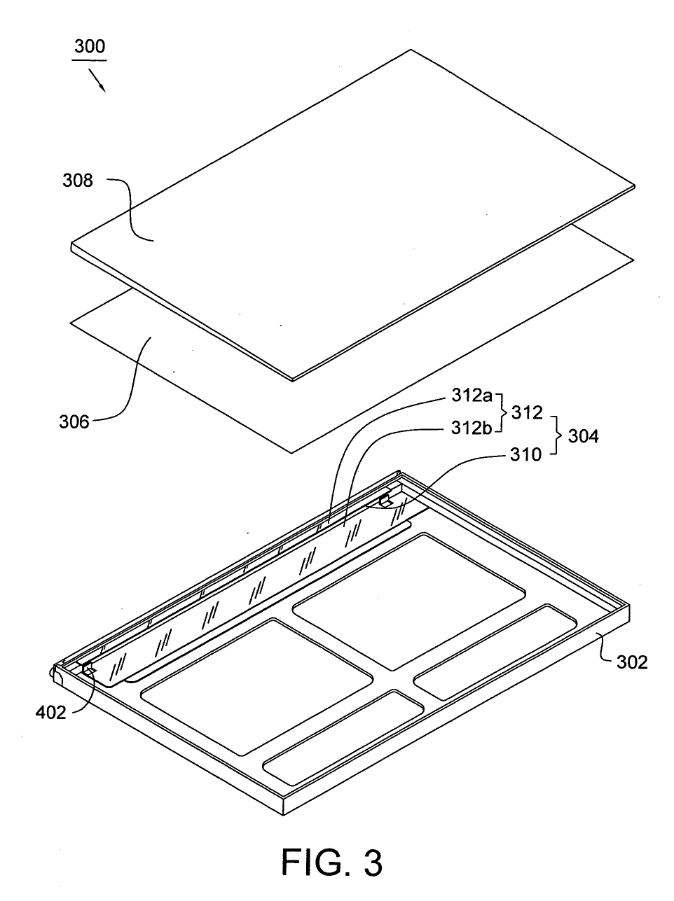

As shown in FIG. 3, the backlight module 300 includes a housing 302, a lamp assembly 304, a reflective sheet 306 which is disposed in the housing 302, and a optical sheet 308 which is disposed on the reflective sheet 306, wherein the optical sheet 308 is a light guide plate in this embodiment. But in another embodiment, the optical sheet 308 is a diffuser plate or others just according to design. The light assembly 304 includes a lamp 310 being the light source and a lamp holder 312. The back light module 300 is utilized to distribute the light from a light source uniformly over the surface of the liquid crystal panel 204 (shown in FIG. 2).

The housing 302 is generally made of plastic material for receiving the light assembly 304, the reflective sheet 306 and the optical sheet 308. The frame 202 (shown in FIG. 2) is joined with the housing 302 for combining the liquid crystal panel 204 and the back light module 300 to the liquid crystal display device 200 (shown in FIG. 2).

The lamp 310 is disposed in the lamp holder 312, and two ends of the lamp 310 are connected with two ends of the lamp holder 312. The lamp 310 is mounted on the frame 302 by means of the lamp holder 312. The lamp holder 312 has a U-shaped body which includes an upper wall 312a and a lower wall 312b opposite to the upper wall 312a. The lamp holder 312 also has a reflective surface (not shown) which faces the lamp 310 for concentrating the light emitted from the lamp 310.

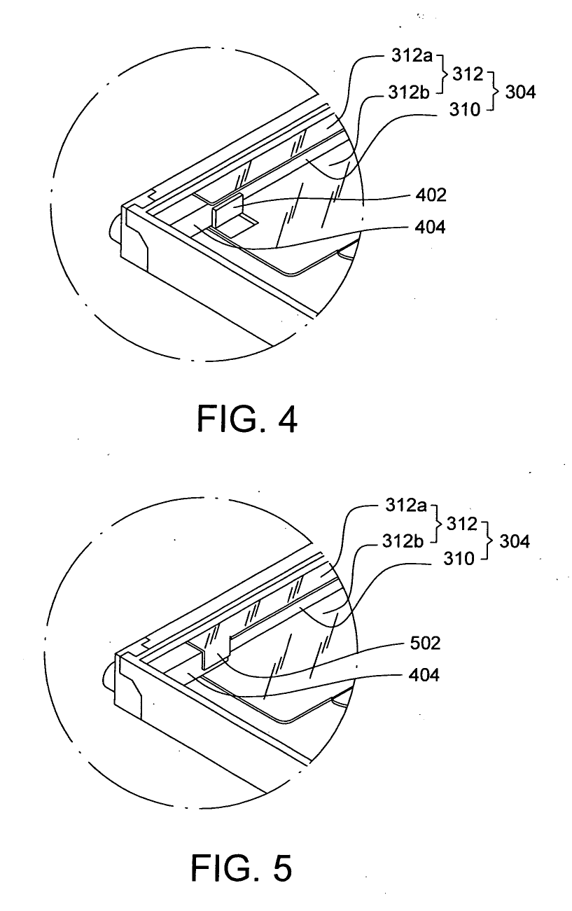

The light assembly 304 is disposed inside the housing 302. Referring FIGS. 3 and 4, the lamp holder 312 includes a pair of first stoppers 402 which are respectively disposed at the two ends of the lamp holder 312 and located between the lamp 310 and the optical sheet 308 (after the reflective sheet 306 and the optical sheet 308 has been disposed in the frame 302). In this embodiment, the first stoppers 402 are formed by cutting and bending the lower wall 312b of the lamp holder 312. The light assembly 304 generally has a pair of elastic elements 404 which are respectively disposed at the two ends of the lamp 310 and are connected with the two ends of the lamp holder 312. Preferably, the first stopper 402 does not exceed the range between the elastic elements 404 so as to avoid obstructing the light emitted from the lamp 310. The length of the first stopper 402 can be substantially the same as the length of the elastic element 404.

Referring to FIG. 5, it depicts a partially perspective view of a backlight module according to another embodiment of the present invention. In this embodiment, the upper wall 312a of the lamp holder 312 has a protrudent portion and the first stopper 502 is formed by bending the protrudent portion of the upper wall 312a.

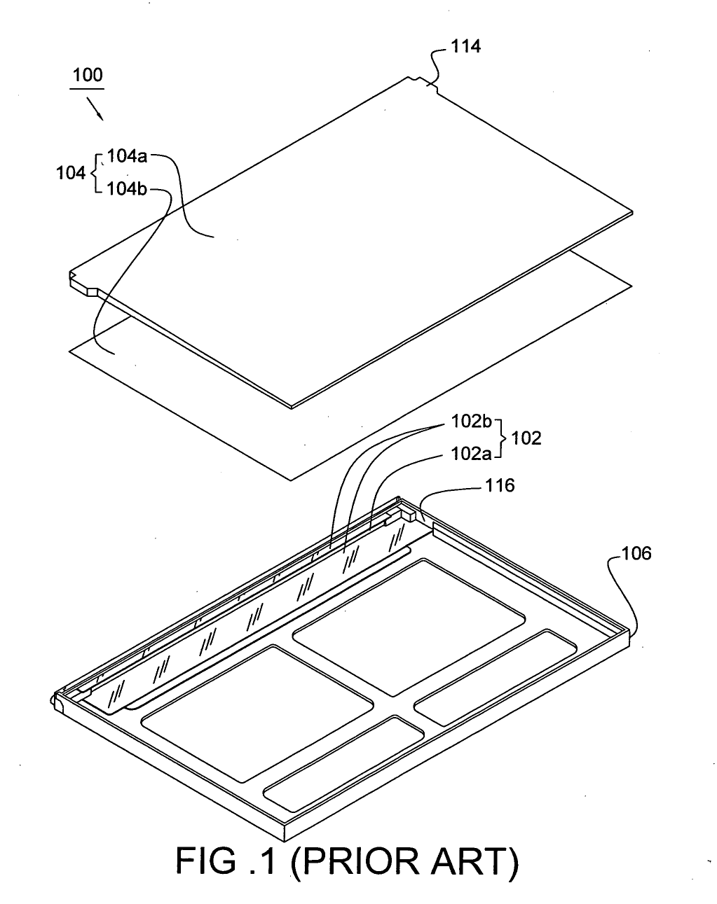

Referring to FIG. 1 again, there is not any structure disposed between the lamp 102 and the light guide plate 104a of the conventional backlight module 100 to prevent the light guide plate 104a from contacting the lamp 102a, and therefore the light guide plate 104a must be provided with the protrusion which is disposed the side thereof and snapped into the concave 116 of the housing 106, whereby securely the light guide plate 104a is not removed to the lamp 102a. Referring to FIGS. 3-5 again, the prevent invention provides the novel lamp assembly 304, which includes the lamp holder 312 having the pair--of first stoppers 402, 502 for preventing the optical sheet 308 from contacting the lamp 310 so as to prevent the lamp 310 from ramming of the optical sheet 308. Thus, the present invention provides the backlight module 300, which includes the optical sheet 308 which can be a structure without the protrusion, thereby solving the problem of the optical design of the protrusion of the optical sheet 308, economizing the material of manufacturing the protrusion, making it easier to attach the adhesive tape to the side of the optical sheet 308 or fully omitting the adhesive tape. In addition, the housing 302 does not need to be provided with the concave corresponding to the protrusion, and therefore the thickness of the side of the housing 302 can be decreased so as to acquire the lighter and thinner backlight module 300. Of course, in order to let the backlight module having better durability, the prevent invention is applied to the backlight module which includes the optical sheet having the protrusion and the housing having the concave corresponding to the protrusion, and is also applied to the backlight module which includes the optical sheet mounted in the housing by using the adhesive tape.

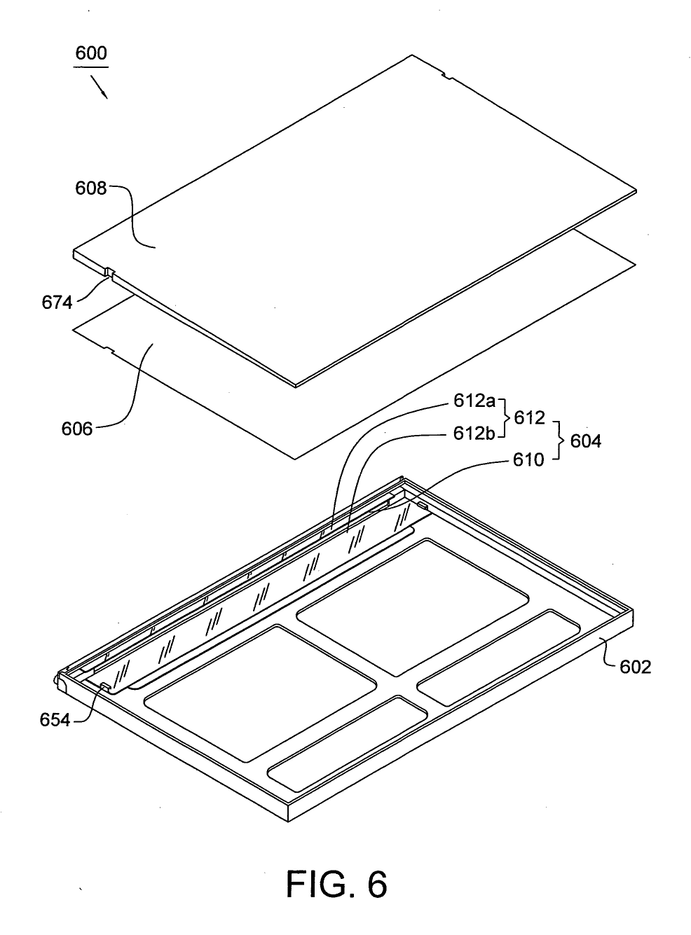

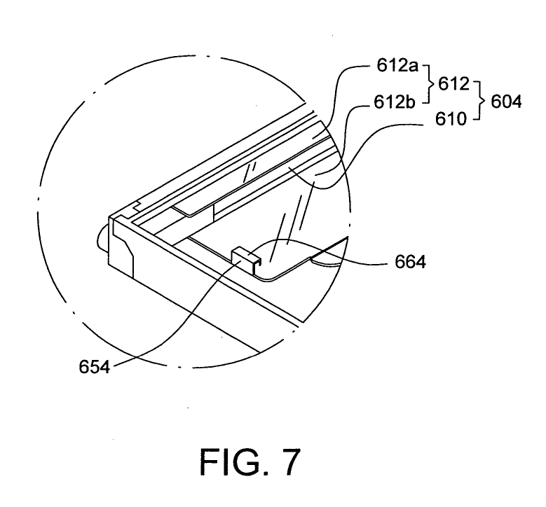

Referring to FIGS. 6 and 7, it depicts a backlight module 600 according to a further embodiment of the present invention. The backlight module 600 is substantially similar to the backlight module 300 wherein the similar elements are designated with the similar reference numerals. The backlight module 600 includes a housing 602, a lamp assembly 604, a reflective sheet 606 which is disposed in the housing 602, and a optical sheet 608 which is disposed on the reflective sheet 606, wherein the optical sheet 608 is a light guide plate in this embodiment. But in another embodiment, the optical sheet 608 is a diffuser plate or others just according to design. In this embodiment, the light assembly 604 includes a lamp holder 612 including at least one second stopper 654, e.g. two stoppers which are respectively disposed near the two ends of the lamp holder 612. In this embodiment, the lamp holder 612 has a U-shaped body which includes an upper wall 612a and a lower wall 612b opposite to the upper wall 612a, and the second stoppers 654 are formed by cutting and bending the lower wall 612b of the lamp holder 612. The lamp holder 612 also has a reflective surface (not shown) which faces the lamp 610 for concentrating the light emitted from the lamp 610. The second stoppers 654 can be rectangular shape 664 or semicircle shape.

Referring to FIG. 6 again, the optical sheet 608 has at least one concave 674 being corresponding to the second stoppers 654 for snapping to the second stoppers 654 so as to mount the optical sheet 608. It is apparent to one of ordinary skill in the art that the contact between the second stoppers 654 and the optical sheet 608 can be-plane, line or point so as to restrict the optical sheet 608 to be removed forward or backward in the direction of the lamp 610. In other words, the freedom degree of the direction of the lamp 610 is restricted, and therefore during ramming test the present invention can avoid the departing optical sheet 608 from the housing so as to increase the durability of the backlight module 600. Furthermore, as compared with the prior art, the lamp holder 612 which includes the second stoppers 654 is not an additional component such that the whole cost of the liquid crystal liquid is not increased. Simultaneously, the lamp holder can be strip-shaped, and therefore the manufacture of the lamp holder having a function of restricting the optical sheet 608 to be removed is easier than the manufacture of the housing having the same function when the liquid crystal liquid has large dimension.

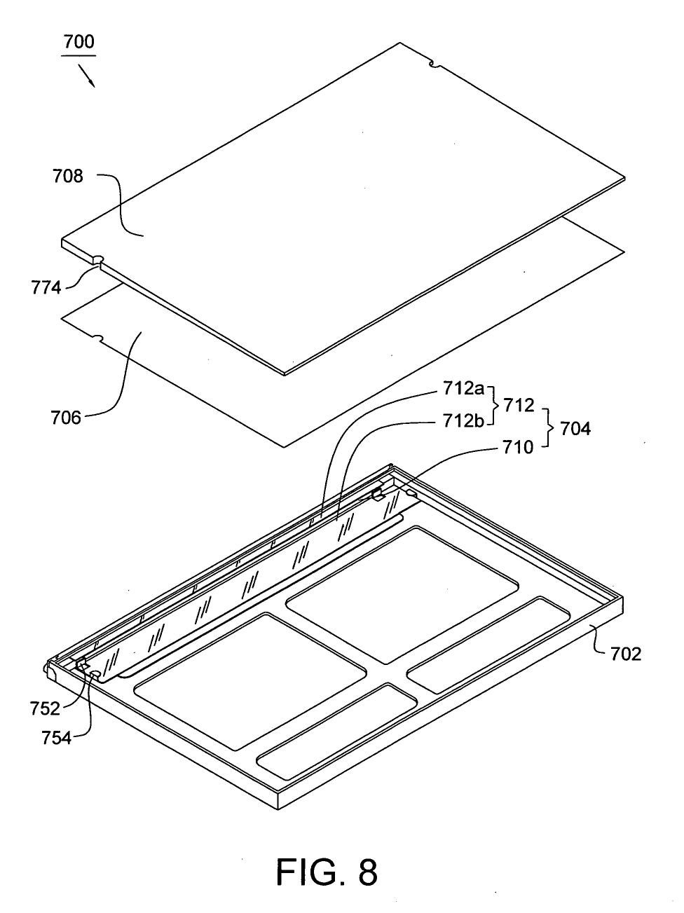

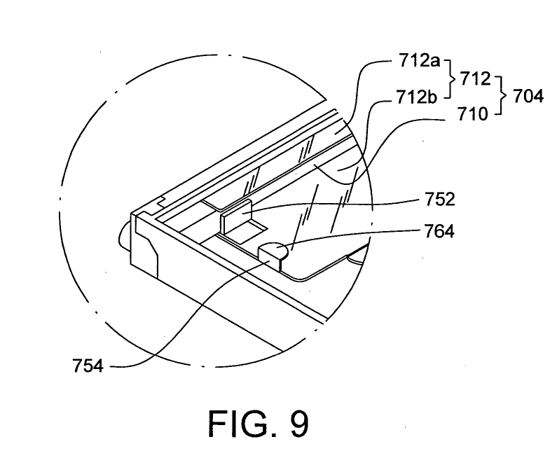

Referring to FIGS. 8 and 9, it depicts a backlight module 700 according to still a further embodiment of the present invention. The backlight module 700 is substantially similar to the backlight module 300 wherein the similar elements are designated with the similar reference numerals. The backlight module 700 includes a housing 702, a lamp assembly 704, a reflective sheet 706 which is disposed in the housing 702, and a optical sheet 708 which is disposed on the reflective sheet 706, wherein the optical sheet 708 is a light guide plate in this embodiment. But in another embodiment, the optical sheet 708 is a diffuser plate or others just according to design. In this embodiment, the light assembly 704 includes a lamp holder 712 including a pair of first stoppers 752 which respectively disposed at the two ends of the lamp holder 712 and located between the lamp 710 and the optical sheet 708. Preferably, the lamp holder 712 further includes at least one second stopper 754, e.g. two stoppers which are respectively disposed near the two ends of the lamp holder 712. In this embodiment, a stopper combination comprises the first stoppers 752 and second stoppers 754 are formed by cutting and bending the lower wall 712b of the lamp holder 712. The second stoppers 754 can be rectangular shape or semicircle shape 764. It is apparent to one of ordinary skill in the art that the upper wall 712a of the lamp holder 712 has a protrudent portion and the first stopper 752 is formed by bending the protrudent portion of the lower wall 712b. The optical sheet 708 has at least one concave 774 corresponding to the second stoppers 754 for snapping to the second stoppers 754 so as to mount the optical sheet 708.

According to the backlight module 700 of the present invention, the lamp holder 712 has the pair of first stopper 752 for preventing the optical sheet 708 from contacting the lamp 710 so as to prevent the lamp 710 from ramming of the optical sheet 708. Furthermore, during ramming test the present invention can avoid the departing optical sheet 708 from the housing 702 so as to increase the durability of the backlight module 700.

Although the invention has been explained in relation to its preferred embodiment, it is not used to limit the invention. It is to be understood that many other possible modifications and variations can be made by those skilled in the art without departing from the spirit and scope of the invention as hereinafter claimed.

1. A lamp assembly comprising:
a lamp having a pair of first ends; and
a lamp holder having a pair of second ends joined with the first ends of the lamp;
wherein the lamp holder comprises a stopper combination disposed near the second ends of the lamp holder.

2. The lamp assembly as claimed in claim 1, wherein the lamp holder has a reflective surface facing the lamp.

3. The lamp assembly as claimed in claim 1, wherein the lamp holder comprises an upper wall and a lower wall being opposite to the upper wall.

4. The lamp assembly as claimed in claim 3, wherein the stopper combination comprises a pair of first stoppers respectively disposed at the second ends of the lamp holder.

5. The lamp assembly as claimed in claim 4, wherein the upper wall has a protrudent portion and the first stopper is formed by bending the protrudent portion of the upper wall.

6. The lamp assembly as claimed in claim 4, wherein the first stoppers are formed by cutting and bending the lower wall.

7. The lamp assembly as claimed in claim 1, comprising a pair of elastic elements respectively disposed between the first ends of the lamp and the second ends of the lamp holder.

8. The lamp assembly as claimed in claim 7, wherein the length of the first stopper is the same as the length of the elastic element.

9. The lamp assembly as claimed in claim 3, wherein the stopper combination comprises a second stopper for mounting an optical sheet.

10. The lamp assembly as claimed in claim 9, wherein the optical sheet has a concave being corresponding to the second stopper.

11. The lamp assembly as claimed in claim 9, wherein the second stopper is formed by cutting and bending the lower wall.

12. The lamp assembly as claimed in claim 4, wherein the stopper combination further comprises a second stopper for mounting an optical sheet.

13. The lamp assembly as claimed in claim 12, wherein the optical sheet has a concave being corresponding to the second stopper.

14. The lamp assembly as claimed in claim 12, wherein the second stopper is formed by cutting and bending the lower wall.

15. A backlight module comprising:
a housing;
a reflective sheet disposed in the housing;
an optical sheet disposed on the reflective sheet; and
a lamp assembly disposed inside the housing and comprising:
a lamp having a pair of first ends; and
a lamp holder having a pair of second ends joined with the first ends of the lamp;
wherein the lamp holder comprises a stopper combination disposed near the second ends of the lamp holder.

16. The backlight module as claimed in claim 15, wherein the lamp holder comprises an upper wall and a lower wall being opposite to the upper wall.

17. The backlight module as claimed in claim 16, wherein the stopper combination comprises a pair of first stoppers respectively disposed at the second ends of the lamp holder.

18. The backlight module as claimed in claim 17, wherein the first stopper located between the lamp and the optical sheet.

19. The backlight module as claimed in claim 16, wherein the stopper combination comprises a second stopper for mounting the optical sheet.

20. The backlight module as claimed in claim 19, wherein the optical sheet has a concave being corresponding to the second stopper.

21. The backlight module as claimed in claim 17, wherein the stopper combination comprises a second stopper for mounting the optical sheet.

22. The backlight module as claimed in claim 21, wherein the optical sheet has a concave being corresponding to the second stopper.

23. The backlight module as claimed in claim 21, wherein the optical sheet is provided with a protrusion and the housing is provided with a concave snapped into the protrusion of the optical sheet.

24. A liquid crystal display device comprising:
a liquid crystal panel;
a frame; and
a backlight module disposed under the liquid crystal panel and comprising:
a housing joined with the frame for disposing the liquid crystal panel between the frame and the housing;
a reflective sheet disposed in the housing;
an optical sheet disposed on the reflective sheet; and
a lamp assembly disposed on a side of the housing and comprising:
a lamp having a pair of first ends; and
a lamp holder mounted in the housing and having a pair of second ends joined with the first ends of the lamp;
wherein the lamp holder comprises a stopper combination disposed near the second ends of the lamp holder.

25. The liquid crystal display device as claimed in claim 24, wherein the lamp holder comprises an upper wall and a lower wall being opposite to the upper wall.

26. The liquid crystal display device as claimed in claim 25, wherein the stopper combination comprises a pair of first stoppers respectively disposed at the second ends of the lamp holder.

27. The liquid crystal display device as claimed in claim 26, wherein the first stopper located between the lamp and the optical sheet.

28. The liquid crystal display device as claimed in claim 25, wherein the stopper combination comprises a second stopper for mounting the optical sheet.

29. The liquid crystal display device as claimed in claim 26, wherein the stopper combination comprises a second stopper for mounting the optical sheet.

30. The liquid crystal display device as claimed in claim 24, further comprising an adhesive tape for mounting the optical sheet to the housing.
